(19) United States
(12) Patent Application Publication
(10) Pub. No.: US 2009/0234700 A1
(43) Pub. Date: Sep. 17, 2009

(54) Systems and Methods for Electronic Interaction with Customers in a Retail Establishment

(76) Inventors: Brian Galvin, Seabeck, WA (US); Alan McCord, Dublin, CA (US); Donald R. Boys, Aromas, CA (US)

Correspondence Address: TUROCY & WATSON, LLP, 127 Public Square, 57th Floor, Key Tower, CLEVELAND, OH, 44114, US

(21) Appl. No.: 12/049,887

(22) Filed: Mar. 17, 2008

(51) Int. Cl. G06Q 30/00; G06Q 10/00

(52) U.S. Cl. 705/9; 705/14; 705/27

(57) ABSTRACT

A service includes a server executing software from a digital memory media, information stored in a data repository and accessible to the server regarding products offered for sale at least one physical retail establishment, and a mobile communication appliance carried and utilized by a customer within the premises of the physical retail establishment and coupled to the server for communication. Information services regarding products displayed for sale are provided to the customer through the appliance within the physical retail establishment.

### BACKGROUND OF THE INVENTION

1. Field of the Invention

This invention is in the broad field of information technology, and pertains more particularly to a system for providing information to customers of retail establishments during shopping sessions.

2. Description of Related Art

It is well known in the art that there are a wide variety of retail vendors who maintain what are known as brick-and-mortar retail establishments where products are displayed and sold. Such establishments include those for big-box establishments like Costco™, building supply establishments like Lowes™ and Home Depot™ and what are typically known as department stores, like Macy's™ and Gottschalks™.

It will not be news to those skilled in the art or to the general public that there are a number of common problems encountered by customers in such establishments, like, for example, finding a sales person to help find a product, determine if a displayed item is in stock or get a unit down from a shelf twenty feet up. Another problem often encountered, particularly in department stores, is finding a station in the establishment where items may be “rung up”, that is, where purchases may be made and items packaged. These are only a few of the many problems customers face.

Most of the retail establishments briefly described above also maintain a presence on the world-wide-web (WWW) with web pages for a customer to browse and select and purchase products. A distinct advantage of web shopping is that the customer may more easily get prices, configurations and other product information before making a purchase. A distinct disadvantage is that customer may not see and feel the actual entity that the customer desires to purchase.

Given the above-described problems, and other information, it has occurred to the inventor that there is an area of search and interaction that might be very useful to persons carrying mobile appliances like cellular telephones and personal digital assistants (PDAs. Potential customers visiting retail establishments, especially establishments that are substantially large, like branches of department stores, building-supply stores, and the like. What is needed in these cases is a localized system for dealing with customers on the premises, and providing both general and in some cases location-based information relative to products and services.

### BRIEF SUMMARY OF THE INVENTION

The present inventors, being aware of many problems encountered by customers in physical retail establishments, what are known in the art as brick-and-mortar stores, and also being knowledgeable about networking systems and equipment, have invented a system for aiding customers and overcoming many of the problems customers frequently encounter.

In one embodiment of the invention a service is provided, comprising a server executing software from a digital memory media, information stored in a data repository and accessible to the server regarding products offered for sale at least one physical retail establishment, and a mobile communication appliance carried and utilized by a customer within the premises of the physical retail establishment and coupled to the server for communication. Information services regarding products displayed for sale are provided to the customer through the appliance within the physical retail establishment.

In another aspect of the invention a method for serving a customer of a physical retail establishment is provided, comprising steps of (a) storing information regarding products in a data repository coupled to a server executing software from a digital memory media; (b) coupling a mobile communication appliance carried by the customer to the server; and (c) providing, by the server, information regarding products displayed for sale to the customer through the appliance within the physical retail establishment.

### BRIEF DESCRIPTION OF THE SEVERAL VIEWS OF THE DRAWINGS

FIG. 1 is a diagram depicting an overall system in an embodiment of the present invention.

FIG. 2 is an illustration of portions of data repository 607 in an embodiment of the present invention.

FIG. 3 is an architectural diagram of a system in another embodiment of the present invention.

### DETAILED DESCRIPTION OF THE INVENTION

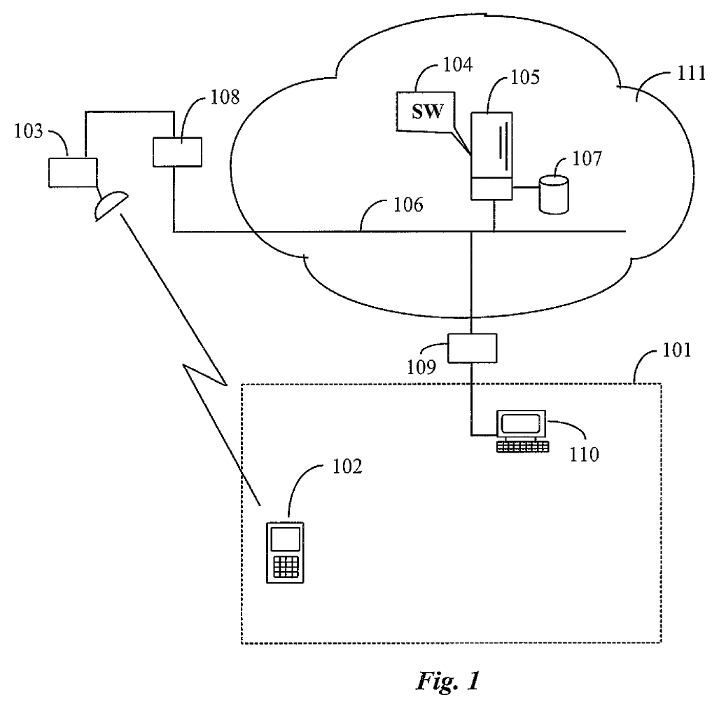

In one embodiment of the invention a system is provided that acts as an aid to potential customers in a physical retail establishment. FIG. 1 is a diagram illustrating a system useful for and by a retail establishment in an embodiment of the invention. Establishment 101 in FIG. 1 illustrates an enterprise establishment, such as, for example, a branch of Macy's™ or Bloomingdales™, or perhaps a branch of CostCo™ or Home Depot™. Establishment 101 is meant to represent any such establishment that is locally implemented (a brick-and-mortar store) and deals in selling goods or services, or both, to customers at the establishment.

A customer within or nearby establishment 101 carries a mobile appliance 102, such as a cellular telephone or a PDA. In some cases appliance 102 is a personal appliance, and in some cases might be an appliance provided to the customer during a visit to the establishment for the customer's use while shopping. In one embodiment, as depicted by FIG. 1, the mobile appliance is a hand-held device that may access the Internet network via a cellular telephone network. In this case a base station 103, through which appliance 102 connects in this example, represents many such stations in a cellular network, and is a station local to establishment 101. Base station 103 is coupled through a telephony apparatus 108, as is known in the art, to line 106, representing all of the interconnections in Internet network 111.

A server 105 executing software 104 and coupled to a data repository 107 is connected to line 106 (Internet-connected). A workstation in establishment 110 is likewise connected to the Internet through an apparatus 109, representing all the various ways a workstation may access the Internet network; so a worker at the enterprise, such as an employee knowledgeable of the system of the invention, may also access server 105.

A customer carrying appliance 102 may enter the establishment by any portal into the establishment, and may typically move around to any customer location on any floor where products may be displayed and customers are free to move around; and where employees of the establishment may also operate to meet and serve customers. In some cases employees may also carry an appliance like appliance 102, and in other cases not.

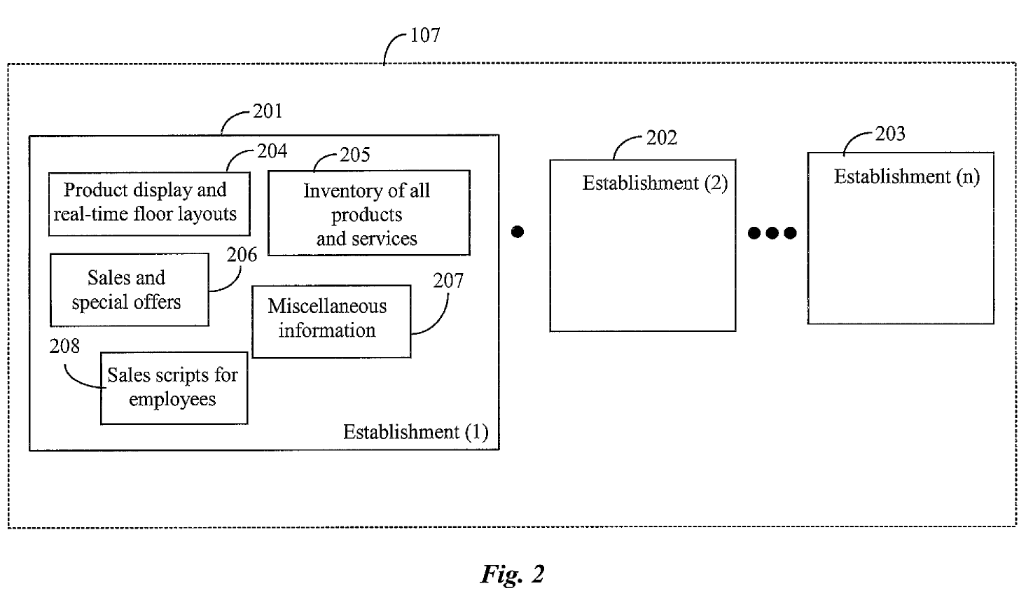

FIG. 2 is a diagrammatical illustration of a part of data repository 107 coupled to server 105. Portion 201 stores information pertinent to one establishment 201, which may be establishment 101 of FIG. 1. Portions 202 through 203 store information pertinent to other retail establishments. In this example, server 105 is dedicated to one company that has a plurality of brick-and-mortar retail establishments. In some embodiments, however, server 105 may serve a variety of disparate companies, each having a plurality of establishments in different physical (geographic) locations.

In this example the information stored includes such as product display and real-time floor layouts 204 for the individual establishment. It is well-known that displays are moved and updated on a regular basis, and therefore the physical layout of establishment 201 changes over time, often on a daily basis. To keep portion 201 relevant in near real time, there is a managerial protocol to keep data portion 201 up to date as changes are made. In one embodiment this is done by specifically designated and authorized employees via workstation 110 (see FIG. 1).

Other sorts of information that may be stored in and accessed from memory part 201 include inventories 205, sales and special offers 206, sales scripts for employees 208, and other information 207. In one case customers may be able to access specific configuration information and manuals for specific products, which may be stored in portion 207 of the data repository. In this manner customers may enjoy a very granular experience, and be sure that products selected for purchase are actually the products they need, and that may be compatible with other hardware and software. This may be particularly useful for electronic products.

In one embodiment a customer carrying an appliance 102 may dial a number to access services provided by a system according to an embodiment of the present invention. The customer may be, for example, a registered client of the system for the parent corporation hosting the physical establishment, such as Macy's™ Inc. related to an individual Macy's™ store location. As a part of registration that customer may be provided with the telephone number, or a URL for accessing services, and in examples to follow the system of the invention, including services provided, will be referred to in many instances as “the service”.

In one embodiment, when a customer calls the number or asserts the URL to access services from server 105, the approximate location of the customer may be discerned by which base station the customer's appliance accesses, as there will likely be only one retail establishment location in the immediate neighborhood of the local base station 103. This discerned information is used by the service to access the correct portion of the data repository that is pertinent to the establishment location.

In another embodiment the establishment may host base stations for various cellular networks on the establishment premises, as an aid in the needed identification. In other embodiments the system may interact with the customer to authenticate the establishment. In the direct interaction mode, when a customer calls in, the server may present the customer with either a selection process to establish the correct establishment, or invite the customer to simply input a city or other locale, which may be by voice.

Once the correct establishment is known by the service, in one embodiment server 105 interacts with customers carrying appliances 102 through execution of software 104, providing useful information to the customers in a variety of ways. For example, in one embodiment a menu system is provided (for customers having an appliance with a display) as a “home page”. The menu system is interactive in the usual sense, so the customer may, for example, select a menu item “first floor” and then see a layout of the first floor of the enterprise, showing product categories and where they are located. The location of men's shoes may, for example, be shown on the first-floor layout. By selecting an area and enlarging (focusing in), such as the men's shoe area, more detailed information may be provided, such as brand names, specific layout including furniture and the like. The information may include number of employees available to serve the customer in the men's shoe area; and whether an employee is presently free to help the customer (presence and availability). This granularity of information in some embodiments requires employees to carry an appliance providing input for presence and availability.

In one embodiment, as described briefly above, a customer may be a registered client of the service, and the service may have a client profile. The profile may include information the client provides to the service as a part of a registration process, and may further include information the service may obtain from other sources. The profile may also include transaction history with the particular client.

When a client customer is on the premises the service may interact with the client by making special offers, and by leading the client to displays and the like based on knowledge of the client's preferences through the client profile. Further, the client may transact with the enterprise, that is, purchase products and services, and authorize payment via the appliance in interaction with server 105. For example, a client customer may enter the establishment, and make contact with the service through his/her portable appliance. The service will immediately discern which enterprise the customer is in, and interact further with the customer based on the information current for that establishment. Much information, of course, will be the same or similar for all or most establishments for the company.

Once contact and communication is accomplished, in this example, the service queries the customer for any real-time purpose or concern. The customer may advise the service through the portable appliance that he is particularly interested in shopping for a new suit. The service sorts the information available for suits, which suits are readily available for display at the particular establishment, and further sort the available options according to the customer's client profile. The service informs the customer of the choices focused at that time for that customer, and advises the customer where to go in the store to gain satisfaction for the present need or desire. The service may also inform one or more sales and/or management people of the developing real-time relationship, and solicit personal aid for that customer, including scripting an available employee based on the customer's desires, profile, transaction history and the like.

This example is not meant to imply that the service interacts with one customer at a time. The service may, in fact, interact with a large number of customers simultaneously, at each of the several establishments for the particular company represented. As each customer makes contact, a new dialogue is opened, and carried along interactively. Purchases may be made and other arrangements concluded in individual ones of the open dialogues, and as sales are made, for example, inventory may be updated, subject, perhaps, to later confirmation.

In an individual dialogue, a wide variance of interaction may take place. The customer in the dialogue may make new requests and indicate new desires and preferences. The customer may indicate via the appliance, when interacting also with an employee, that he or she prefers a different person for personal interaction. The customer may make a broad range of inquiries, such as when new stock may be available, when a sale may terminate, whether, if an item is purchased now, it may be subject in a near term to a sale price that is not presently available.

In a simple case the appliance may be a relatively low-end cellular telephone, and the entire interaction may be a voice interaction between the customer and the service, in which case the service, through server 105 and software 104, may act substantially as an interactive voice response (IVR) server. In other instances, where the customer's appliance is more of a smart phone, having a display capability, the interaction may be through interactive display interfaces, like a web page, for example.

In one embodiment a company may have a service as described thus far, further enabled by appliances provided at particular establishments by the company. The customer in that case is assigned an appliance, and is expected to return the appliance at the end of session, so it may be cleaned and reassigned to another customer later. In this instance customer location within an establishment may be determined and provided to the service through a triangulation system wholly within the enterprise.

In some embodiments wherein appliances are provided for customers, such appliances may be available at the establishment, and the customer may check out an appliance and return it at the end of a shopping session, as briefly described above. In some other embodiments certain customers, for example, preferred customers, may be provided with an appliance which they may keep as long as their customer status is maintained. In some cases this appliance may be a smart phone that the customer may use for other purposes than just in establishments of the particular parent company of the several establishments.

In a relatively simple example of the present invention customers having cellular telephones may access server 105 by telephone, such as on a land line, and interact with the service as an IVR, as described above, wherein the service will determine the location of the establishment where the customer is shopping, and interact with the customer on a few relatively simple issues, such as current sales at that establishment, upcoming sales along with prices, etc. Another service that may be provided to such customers is an appointment service, wherein a customer may call the service, provide a time and an establishment, along with an interest, such as buying a new suit or a pair of shoes, and the service will record an appointment for the customer, assign an employee to the appointment, and provide the employee with pertinent information regarding the customer, the customer's immediate interest, and so forth. In this service a feedback mechanism may be provided wherein both the customer and the employee may separately rate the encounter.

It may be seen by the descriptions above that there is a wide variety of appliances that may be used, there may be a variety of ways appliances may connect to the service, and there is truly a wide variety of services that may be performed by the service in distinct embodiments of the invention. In another embodiment appliances used by customers may be enabled for radio-frequency identification (RFID), so customers may query prices for products simply by having the appliance in close proximity to the products.

It was described briefly above that to stay current and to provide good service, the data repository 107 will have to be updated by each establishment on perhaps a daily, or at least a weekly basis. Specific employees may be authorized to do this, and such employees will typically use one or more workstations 110 (FIG. 1) to access the service, select input and update functions provided interactively by SW 104, and make necessary changes in layout, inventory and the like, so information provided to customers for that establishment will be correct.

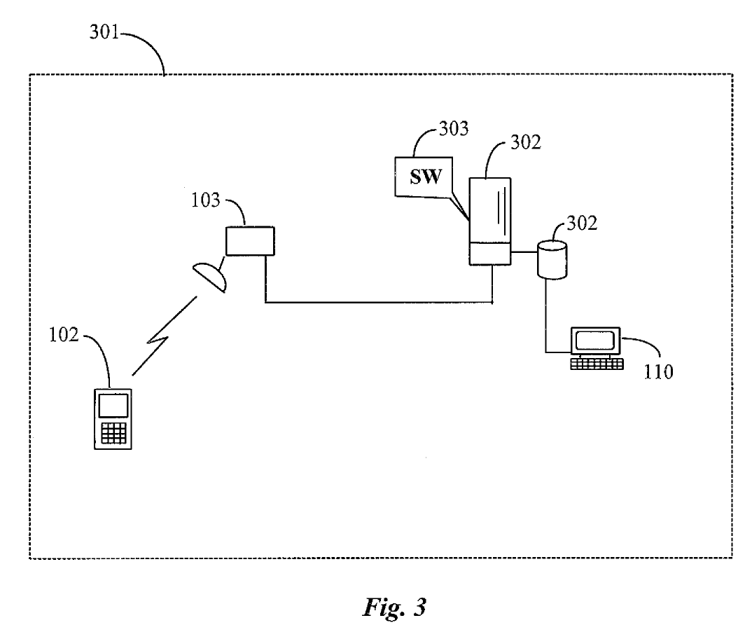

In alternative embodiments of the invention, as shown in FIG. 3, appliances will not contact a network server as thus far described, such as server 105 in the internet network. The service may alternatively be provided by a similar server 302, with one in each of individual ones of the establishments. Server 302 is shown in an establishment 301 in this example, which is one of a plurality of establishments of a company. In this case the appliance 102 may interact wirelessly with a base station 103 within establishment 301. In this case a worker using workstation 110 may keep data repository 302 up-to-date so that customers get proper information.

In one embodiment, such as shown in FIG. 3, a customer, particularly using a special appliance provided by the establishment, may be tracked within the establishment by a triangulation system similar to GPS but on a much smaller scale. In this case stations at different locations in the establishment ping a device in the appliance, and triangulation is used to determine the customer's location in the establishment. The location may be used as a variable in determining information to deliver to the customer.

Most if not all services described thus far may be provided in the example of FIG. 3, including for example an ability to make an appointment for interaction with an employee of the establishment. One problem customers often encounter in such a retail establishment is an ability to find a salesperson in a department, to help in finding or suggesting a particular product or item. In embodiments of this invention that problem may no longer exist. Another is encountering a sales register with a short line. Again the customer with an appliance in touch with the service of the invention may simply query the system for a better location.

Those with skill in the art will realize that there may be many changes made in embodiments of the invention without parting from the spirit and scope of the invention. Accordingly the invention is limited only by the scope of the claims that follow.

1. A system, comprising:
a data repository that stores information regarding products offered for sale at at least one physical retail establishment; and
a server that provides information services regarding products displayed for sale to one or more mobile communication appliances within the premises of the physical retail establishment.

2. The system of claim 1, wherein the server is connected to an Internet network, and communicates with the one or more mobile communication appliances over a cellular network via the Internet network.

3. The system of claim 1, wherein the server provides; an interactive interface to the one or more mobile communication appliances.

4. The system of claim 3, wherein the interactive interface is a voice response system.

5. (canceled)

6. The system of claim 1, wherein the information services comprise floor layouts of product displays or departments.

7. The system of claim 1, wherein the information services comprise information about sales or special offers.

8. The system of claim 1, wherein the data repository stores information regarding a plurality of separate physical retail establishments related to a single company.

9. The system of claim 8, wherein the server determines a physical retail establishment related to the one or more mobile communication appliances based at least in part on a detected location of the one or more mobile communication appliances and serves information related to the physical retail establishment to the one or more mobile communication appliances.

10. The system of claim 9, wherein the server determines the physical retail establishment by discerning a cellular base station to which the one or more mobile communication appliances are connected.

11. The system of claim 1, wherein the server is on-site at one physical retail establishment.

12. The system of claim 11, further comprising a triangulation system for determining location within the establishment of at least one of the one or more mobile communication appliances.

13. The system of claim 12, wherein the server utilizes the location of the at least one mobile communication appliance in selecting information services to be provided to the mobile communication appliance.

14. (canceled)

15. The system of claim 1, wherein at least one of the one or more mobile communication appliances relates to an employee of the physical retail establishment.

16. The system of claim 15, wherein the server provides sales scripts to the at least one mobile communication appliance related to the employee.

17. The system of claim 1, wherein at least one of the information services enables the one or more mobile communication appliances to make create an appointment for sales interaction at the physical retail establishment.

18. A method comprising:
utilizing at least one computing device to perform the acts steps of:
storing information regarding products purchasable at a physical retail establishment in a data repository; and
providing information regarding products displayed for sale to a mobile communication appliance based at least in part on detecting presence of the mobile communication appliance within the physical retail establishment.

19. The method of claim 18, wherein the at least one computing device further performs the acts of connecting to an Internet network and communicating with the mobile communication appliance the over a cellular network via the Internet network.

20. The method of claim 18, wherein the at least one computing device further performs the act of providing an interactive interface to to the mobile communication appliance.

21. The method of claim 20, wherein the act of providing the interactive interface includes providing a voice response system.

22. (canceled)

23. The method of claim 18, wherein the act of providing information regarding products displayed for sale comprises providing floor layouts of product displays or departments at the physical retail establishment.

24. The method of claim 18, wherein the act of providing information regarding products displayed for sale comprises providing information about sales or special offers at the physical retail establishment.

25. The method of claim 19, wherein the at least one computing device further performs the act of storing information in the data repository regarding a plurality of separate physical retail establishments belonging to a single company.

26. The method of claim 25, wherein, the at least one computing device further performs the acts of determining the specific physical retail establishment at least in pail by detecting presence of the mobile communication appliance in the physical retail establishment and providing information associated specifically with that physical retail establishment to the mobile communication appliance.

27. The method of claim 26, wherein the at least one computing device further performs the act of determining the specific retail establishment by detecting a cellular base station to which the mobile communication appliance is connected.

28. (canceled)

29. The method of claim 28, wherein the at least one computing device further performs the act of employing a triangulation system for determining a location within the establishment of the mobile communication appliance.

30. The method of claim 29, wherein providing information to the mobile communication appliance is based at least in part on the location of the mobile communication appliance within the physical retail establishment.

31. (canceled)

32. The method of claim 18, wherein the act of providing information regarding products displayed for sale includes providing the information to one or more mobile communication appliances related to one or more employees of the physical retail establishment.

33. The method of claim 32, wherein the at least one computing device further performs the act of providing sales scripts to the one or more mobile communication appliances related to the one or more employees.

34. The method of claim 18, wherein the act of providing information regarding products displayed for sale includes providing a mechanism for making an appointment for sales interaction at the physical establishment.

35. The system of claim 15, wherein the server further obtains desired purchase information from a disparate mobile communication appliance related to a customer.

36. The system of claim 35, wherein the information services provided to the mobile communication appliance related to the employee comprises the desired purchase information.

37. The method of claim 32, wherein the act of providing information regarding products displayed for sale further includes providing desired purchase information obtained from a disparate mobile communication appliance related to a customer to the one or more mobile communication appliances related to the one or more employees.

38. A system, comprising:
a mobile communication appliance that provides contextual information to a server related to a retail establishment and receives product information from the server based at least in part on the contextual information and a physical location of the mobile communication appliance within the retail establishment; and
an interface that displays the product information along with one or more selectable menu options.

39. The system of claim 38, wherein the product information relates to a location of a desired product indicated by the contextual information and the interface displays the location on a map of the retail establishment.

40. The system of claim 39, further comprising a triangulation system that obtains a location of the mobile communication appliance within the retail establishment, wherein the interface indicates the location of the mobile communication appliance on the map.

41. The system of claim 38, wherein the product information relates to presence and availability information for one or more employees of the retail establishment.

42. The system of claim 41, wherein the selectable menu options relate to requesting service from the one or more employees in a portion of the retail establishment.

43. A method, comprising:
utilizing at least one mobile appliance to perform the acts of:
detecting a server related to a physical retail establishment based on at least in part on presence within the physical retail establishment;
providing contextual information to the server related to a real-time concern; and
receiving product information from the server based at least in part on the contextual information.

44. The method of claim 43, wherein the at least one mobile appliance further performs the act of communicating with a base station over a cellular telephone network, the contextual information is provided to the server via the base station.

45. The method of claim 43, wherein the at least one mobile appliance further performs the act of authorizing payment for at least one product in the product information based at least in part on a customer profile.
